(19) United States
(12) Patent Application Publication
(10) Pub. No.: US 2018/0016407 A1
(43) Pub. Date: Jan. 18, 2018

(54) FLAME RETARDANT POLY(ARYLENE ETHER)/POLYSTYRENE FOAMED MATERIAL AND ASSOCIATED METHOD OF MAKING AND ARTICLE

(71) Applicant: SABIC Global Technologies B.V., Bergen op Zoom (NL)

(72) Inventors: Adrie Landa, Pater Dehonlaan (NL); Johan Maria Krist, Kerkrade (NL)

(73) Assignee: SABIC Global Technologies B.V., Bergen op Zoom (NL)

(21) Appl. No.: 15/545,764

(22) PCT Filed: Sep. 25, 2015
(86) PCT No.: PCT/IB2015/057400

§ 371 Date: Jul. 24, 2017

Related U.S. Application Data
(60) Provisional application No. 62/109,674, filed on Jan. 30, 2015.

(51) Int. Cl. C08J 9/00; C08J 9/14

(52) U.S. Cl. CPC C08J 9/0061; C08J 9/141; C08J 9/0038; C08J 2371/10; C08J 2201/03; C08J 2383/12; C08J 2425/06; C08J 2203/14

(57) ABSTRACT

A foamed material includes specific amounts of a polystyrene, an organophosphate ester, and a poly(phenylene ether) or a poly(phenylene ether)-polysiloxane block copolymer or a combination thereof. The material is foamed with a C₃-C₅ alkane blowing agent. The foamed material is useful as insulation in the construction of walls and ceilings.

### BACKGROUND OF THE INVENTION

Foamed plastic materials such as extruded foam board are widely used in building applications. Requirements for these applications are excellent thermal insulation properties, good compression strength, and excellent flame retardant properties. The majority of the commercial flame retardant foams in building applications are based on halogenated flame retardants. Two examples of commercial flame retardant foamed materials used in building are flame retardant eXtruded PolyStyrene (XPS) and flame retardant Expandable PolyStyrene (EPS). These foamed materials contain brominated flame retardants. For example, HexaBromoCycloDodecane (HBCD) is the most commonly used halogenated FR agent used in polystyrene foamed materials. However, in October 2008, the European Chemicals Agency included HBCD in the list of Substances of Very High Concern, and use of HBCD in Europe will become prohibited in August 2015. Increasingly, regulatory authorities are demanding that insulating foams exclude halogenated flame retardants. There is therefore a needed for insulating foam compositions that exhibit excellent flame retardancy without incorporating halogenated flame retardants. In particular, there is a needed for foamed materials that pass the EN ISO 11925-2:2010 test for a Class E rating under both surface and edge test conditions.

### BRIEF SUMMARY OF EMBODIMENTS OF THE INVENTION

One embodiment is a foamed material comprising, based on the total weight of the foamed material: 45 to 82 weight percent of a poly(phenylene ether), a poly(phenylene ether)-polysiloxane block copolymer, or a combination thereof; 10 to 47 weight percent of a polystyrene; and 8 to 20 weight percent of an organophosphate ester; wherein the foamed material has a density of 30 to 100 kilograms per cubic meter, measured at 23° C.; wherein the foamed material is the product of a process comprising melt blending in an extruder the poly(phenylene ether), the poly(phenylene ether)-polysiloxane block copolymer, or the combination thereof, the polystyrene, and the organophosphate ester to form a molten thermoplastic composition, adding a blowing agent to the extruder at a rate of 2 to 10 weight percent based on the weight of the molten thermoplastic composition to form a pre-foamed molten thermoplastic composition, wherein the blowing agent is selected from the group consisting of propane, 2-methylpropane, n-butane, 2-methylbutane, n-pentane, neopentane, and combinations thereof, and extruding the pre-foamed molten thermoplastic composition from the extruder to form the foamed material.

Another embodiment is a method of making a foamed material, the method comprising melt blending in an extruder components comprising, based on the total weight of the foamed material, 45 to 82 weight percent of a poly(phenylene ether), a poly(phenylene ether)-polysiloxane block copolymer, or a combination thereof, 10 to 47 weight percent of a polystyrene, and 8 to 20 weight percent of an organophosphate ester to form a molten thermoplastic composition; adding a blowing agent to the extruder at a rate of 2 to 10 weight percent based on the weight of the molten thermoplastic composition to form a pre-foamed molten thermoplastic composition, wherein the blowing agent is selected from the group consisting of propane, 2-methylpropane, n-butane, 2-methylbutane, n-pentane, neopentane, and combinations thereof; and extruding the pre-foamed molten thermoplastic composition from the extruder to form the foamed material; wherein the foamed material has a density of 30 to 100 kilograms per cubic meter, measured at 23° C.; and wherein weight percent values are based on the total weight of the foamed material.

Another embodiment is an article comprising the foamed material.

These and other embodiments are described in detail below.

### DETAILED DESCRIPTION OF THE INVENTION

The present inventors have determined foamed materials capable of pass the EN ISO 11925-2:2010 test for a Class E rating under both surface and edge test conditions can be prepared using the compositions and methods described herein. This desired flame retardancy can be achieved without using halogenated flame retardants.

One embodiment is a foamed material comprising, based on the total weight of the foamed material: 45 to 82 weight percent of a poly(phenylene ether), a poly(phenylene ether)-polysiloxane block copolymer, or a combination thereof; 10 to 47 weight percent of a polystyrene; and 8 to 20 weight percent of an organophosphate ester; wherein the foamed material has a density of 30 to 100 kilograms per cubic meter, measured at 23° C.; wherein the foamed material is the product of a process comprising melt blending in an extruder the poly(phenylene ether), the poly(phenylene ether)-polysiloxane block copolymer, or the combination thereof, the polystyrene, and the organophosphate ester to form a molten thermoplastic composition, adding a blowing agent to the extruder at a rate of 2 to 10 weight percent based on the weight of the molten thermoplastic composition to form a pre-foamed molten thermoplastic composition, wherein the blowing agent is selected from the group consisting of propane, 2-methylpropane, n-butane, 2-methylbutane, n-pentane, neopentane, and combinations thereof, and extruding the pre-foamed molten thermoplastic composition from the extruder to form the foamed material.

The foamed material comprises a poly(phenylene ether), a poly(phenylene ether)-polysiloxane block copolymer, or a combination thereof. Poly(phenylene ether)s include those comprising repeating structural units having the formula

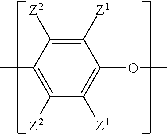

wherein each occurrence of Z¹ is independently C₁-C₁₂ hydrocarbylthio, C₁-C₁₂ hydrocarbyloxy, C₂-C₁₂ halohydrocarbyloxy wherein at least two carbon atoms separate the halogen and oxygen atoms, or unsubstituted or substituted C₁-C₁₂ hydrocarbyl provided that the hydrocarbyl group is not tertiary hydrocarbyl; and each occurrence of Z² is independently hydrogen, C₁-C₁₂ hydrocarbylthio, C₁-C₁₂ hydrocarbyloxy, C₂-C₁₂ halohydrocarbyloxy wherein at least two carbon atoms separate the halogen and oxygen atoms, or unsubstituted or substituted C₁-C₁₂ hydrocarbyl provided that the hydrocarbyl group is not tertiary hydrocarbyl. As used herein, the term “hydrocarbyl”, whether used by itself, or as a prefix, suffix, or fragment of another term, refers to a residue that contains only carbon and hydrogen. The residue can be aliphatic or aromatic, straight-chain, cyclic, bicyclic, branched, saturated, or unsaturated. It can also contain combinations of aliphatic, aromatic, straight chain, cyclic, bicyclic, branched, saturated, and unsaturated hydrocarbon moieties. However, when the hydrocarbyl residue is described as substituted, it may, optionally, contain heteroatoms (other than halogens) over and above the carbon and hydrogen members of the substituent residue. Thus, when specifically described as substituted, the hydrocarbyl residue can also contain one or more carbonyl groups, amino groups, hydroxyl groups, or the like, or it can contain heteroatoms within the backbone of the hydrocarbyl residue. As one example, Z¹ can be a di-n-butylaminomethyl group formed by reaction of a terminal 3,5-dimethyl-1,4-phenyl group with the di-n-butylamine component of an oxidative polymerization catalyst.

The poly(phenylene ether) can comprise molecules having aminoalkyl-containing end group(s), typically located in a position ortho to the hydroxyl group. Also frequently present are tetramethyldiphenoquinone (TMDQ) end groups, typically obtained from 2,6-dimethylphenol-containing reaction mixtures in which tetramethyldiphenoquinone by-product is present. The poly(phenylene ether) can be in the form of a homopolymer, a copolymer, a graft copolymer, an ionomer, or a block copolymer, as well as combinations thereof.

In some embodiments, the poly(phenylene ether) comprises a poly(phenylene ether)-polysiloxane block copolymer. As used herein, the term “poly(phenylene ether)-polysiloxane block copolymer” refers to a block copolymer comprising at least one poly(phenylene ether) block and at least one polysiloxane block.

In some embodiments, the poly(phenylene ether)-polysiloxane block copolymer is prepared by an oxidative copolymerization method. In this method, the poly(phenylene ether)-polysiloxane block copolymer is the product of a process comprising oxidatively copolymerizing a monomer mixture comprising a monohydric phenol and a hydroxyaryl-terminated polysiloxane. In some embodiments, the monomer mixture comprises 70 to 99 parts by weight of the monohydric phenol and 1 to 30 parts by weight of the hydroxyaryl-terminated polysiloxane, based on the total weight of the monohydric phenol and the hydroxyaryl-terminated polysiloxane. The hydroxyaryl-diterminated polysiloxane can comprise a plurality of repeating units having the structure

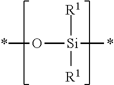

wherein each occurrence of R¹ is independently hydrogen, C₁-C₁₂ hydrocarbyl or C₁-C₁₂ halohydrocarbyl; and two terminal units having the structure

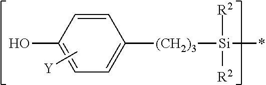

wherein Y is hydrogen, C₁-C₁₂ hydrocarbyl, C₁-C₁₂ hydrocarbyloxy, or halogen, and wherein each occurrence of R² is independently hydrogen, C₁-C₁₂ hydrocarbyl or C₁-C₁₂ halohydrocarbyl. In a very specific embodiment, each occurrence of R¹ and R² is methyl, and Y is methoxy.

In some embodiments, the monohydric phenol comprises 2,6-dimethylphenol, and the hydroxyaryl-terminated polysiloxane has the structure

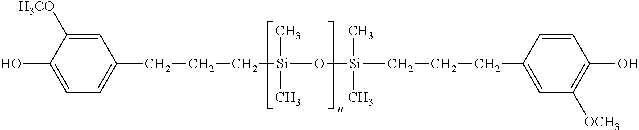

wherein n is, on average, 5 to 100, specifically 30 to 60.

The oxidative copolymerization method produces poly(phenylene ether)-polysiloxane block copolymer as the desired product and poly(phenylene ether) (without an incorporated polysiloxane block) as a by-product. It is not necessary to separate the poly(phenylene ether) from the poly(phenylene ether)-polysiloxane block copolymer. The poly(phenylene ether)-polysiloxane block copolymer can thus be utilized as a “reaction product” that includes both the poly(phenylene ether) and the poly(phenylene ether)-polysiloxane block copolymer. Certain isolation procedures, such as precipitation from isopropanol, make it possible to assure that the reaction product is essentially free of residual hydroxyaryl-terminated polysiloxane starting material. In other words, these isolation procedures assure that the polysiloxane content of the reaction product is essentially all in the form of poly(phenylene ether)-polysiloxane block copolymer. Detailed methods for forming poly(phenylene ether)-polysiloxane block copolymers are described in U.S. Pat. No. 8,017,697 to Carrillo et al., and U.S. Patent Application Publication No. US 2012/0329961 A1 of Carrillo et al.

In some embodiments, the poly(phenylene ether), the poly(phenylene ether)-polysiloxane block copolymer, or the combination thereof has an intrinsic viscosity of 0.25 to 1 deciliter per gram measured by Ubbelohde viscometer at 25° C. in chloroform. Within this range, the poly(phenylene ether) intrinsic viscosity can be 0.3 to 0.65 deciliter per gram, more specifically 0.25 to 0.5 deciliter per gram, even more specifically 0.29 to 0.45 deciliter per gram.

In some embodiments, the poly(phenylene ether), the poly(phenylene ether)-polysiloxane block copolymer, or the combination thereof consists of the poly(phenylene ether). The poly(phenylene ether) can be, for example, a homopolymer or copolymer of monomers selected from the group consisting of 2,6-dimethylphenol, 2,3,6-trimethylphenol, and combinations thereof.

In other embodiments, the poly(phenylene ether), the poly(phenylene ether)-polysiloxane block copolymer, or the combination thereof consists of the combination of the poly(phenylene ether) and the poly(phenylene ether)-polysiloxane block copolymer. In these embodiments, the poly(phenylene ether)-polysiloxane block copolymer can, for example, contribute 0.05 to 5 weight percent, specifically 0.1 to 5 weight percent, more specifically 0.2 to 4 weight percent, of siloxane groups to the foamed material as a whole.

The foamed material comprises the poly(phenylene ether), the poly(phenylene ether)-polysiloxane block copolymer, or the combination thereof in an amount of 42 to 82 weight percent, based on the total weight of the foamed material. Within this range, the amount can be 48 to 75 weight percent.

In addition to the poly(phenylene ether), the poly(phenylene ether)-polysiloxane block copolymer, or the combination thereof, the foamed material comprises polystyrene. As used herein, the term polystyrene refers to a homopolymer of styrene. Thus, the residue of any monomer other than styrene is excluded from the polystyrene. The polystyrene can be atactic, syndiotactic, or isotactic. In some embodiments, the polystyrene comprises an atactic polystyrene having a melt flow index of 1.5 to 15 grams per 10 minutes, measured at 200° C. and 5 kilogram load according to ASTM D1238-13. Within this range, the melt flow index can be 3 to 14 grams per 10 minutes, specifically 5 to 13 grams per 10 minutes.

The foamed material comprises the polystyrene in an amount of 10 to 47 weight percent, based on the total weight of the foamed material. Within this range, the weight percent polystyrene can be 10 to 35 weight percent.

The foamed material further comprises an organophosphate ester. Exemplary organophosphate ester flame retardants include phosphate esters comprising phenyl groups, substituted phenyl groups, or a combination of phenyl groups and substituted phenyl groups, bis-aryl phosphate esters based upon resorcinol such as, for example, resorcinol bis(diphenyl phosphate), as well as those based upon bisphenols such as, for example, bisphenol A bis(diphenyl phosphate). In some embodiments, the organophosphate ester is selected from tris(alkylphenyl) phosphates (for example, CAS Reg. No. 89492-23-9 or CAS Reg. No. 78-33-1), resorcinol bis(diphenyl phosphate) (CAS Reg. No. 57583-54-7), bisphenol A bis(diphenyl phosphate) (CAS Reg. No. 181028-79-5), triphenyl phosphate (CAS Reg. No. 115-86-6), tris(isopropylphenyl) phosphates (for example, CAS Reg. No. 68937-41-7), t-butylphenyl diphenyl phosphates (CAS Reg. No. 56803-37-3), bis(t-butylphenyl) phenyl phosphates (CAS Reg. No. 65652-41-7), tris(t-butylphenyl) phosphates (CAS Reg. No. 78-33-1), and combinations thereof. In some embodiments, the organophosphate ester comprises resorcinol bis(diphenyl phosphate).

The foamed material comprises the organophosphate ester in an amount of 8 to 20 weight percent, based on the total weight of the foamed material. Within this range, the organophosphate ester amount can be 15 to 20 weight percent.

One advantage of the foamed material is that it can exhibit good flame retardancy without using substantial amounts of halogenated flame retardants. For example, in some embodiments the foamed material comprises less than or equal to 1,500 parts per million by weight total of chlorine, bromine, and iodine, based on the total weight of the foamed material.

The foamed material can, optionally, further comprise 0.5 to 2 weight percent talc, based on the total weight of the foamed material.

The foamed material can, optionally, further comprise 0.5 to 2 weight percent polyethylene, based on the total weight of the foamed material.

The foamed material can be formed by a process comprising melt blending in an extruder the poly(phenylene ether), the poly(phenylene ether)-polysiloxane block copolymer, or the combination thereof, the polystyrene, and the organophosphate ester to form a molten thermoplastic composition; adding a blowing agent to the extruder at a rate of 2 to 10 weight percent, specifically 3 to 8 weight percent, based on the weight of the molten thermoplastic composition to form a pre-foamed molten thermoplastic composition, wherein the blowing agent is selected from the group consisting of propane, 2-methylpropane, n-butane, 2-methylbutane, n-pentane, neopentane, and combinations thereof; and extruding the pre-foamed molten thermoplastic composition from the extruder to form the foamed material. The process preferably further includes a step of removing residual blowing agent from the foamed material. For example, the foamed material can be held at 70° C. for five days in a hot air oven to remove residual blowing agent. In some embodiments, the blowing agent is 2-methylpropane.

The foamed material can, optionally, minimize or exclude components other than those described herein as required. For example, in some embodiments, the foamed material comprises less than or equal to 0.5 weight percent, or entirely excludes, polyamides. As another example, in some embodiments, the foamed material comprises less than or equal to 0.5 weight percent, or entirely excludes, polyolefins. As another example, in some embodiments, the foamed material comprises less than or equal to 0.5 weight percent, or entirely excludes, impact modifiers such as rubber-modified polystyrene, unhydrogenated block copolymers of polystyrene and a conjugated diene such as butadiene or isoprene, and hydrogenated block copolymers of polystyrene and a conjugated diene such as butadiene or isoprene. As another example, the blowing agent used to form the foamed material excludes halogenated blowing agents.

In a very specific embodiment of the foamed material, the poly(phenylene ether), the poly(phenylene ether)-polysiloxane block copolymer, or the combination thereof consists of the poly(phenylene ether); the polystyrene comprises an atactic homopolystyrene having a melt flow index of 1.5 to 15 grams per 10 minutes, measured at 200° C. and 5 kilogram load according to ASTM D1238-13; the organophosphate ester comprises resorcinol bis(diphenyl phosphate); the foamed material comprises less than or equal to 1,500 parts per million by weight total of chlorine, bromine, and iodine, based on the total weight of the foamed material; and the foamed material comprises, based on the total weight of the foamed material, 48 to 75 weight percent of the poly(phenylene ether), the poly(phenylene ether)-polysiloxane block copolymer, or the combination thereof, 10 to 35 weight percent of the polystyrene, and 15 to 20 weight percent of the organophosphate ester.

In another very specific embodiment, the poly(phenylene ether), the poly(phenylene ether)-polysiloxane block copolymer, or the combination thereof consists of the combination of the poly(phenylene ether) and the poly(phenylene ether)-polysiloxane block copolymer; the polystyrene comprises an atactic homopolystyrene having a melt flow index of 1.5 to 15 grams per 10 minutes, measured at 200° C. and 5 kilogram load according to ASTM D1238-13; the organophosphate ester comprises resorcinol bis(diphenyl phosphate); the foamed material comprises less than or equal to 1,500 parts per million by weight total of chlorine, bromine, and iodine, based on the total weight of the foamed material; and the foamed material comprises, based on the total weight of the foamed material, 48 to 75 weight percent of the poly(phenylene ether), the poly(phenylene ether)-polysiloxane block copolymer, or the combination thereof, 10 to 35 weight percent of the polystyrene, and 15 to 20 weight percent of the organophosphate ester.

The foamed material has a density of 30 to 100 kilograms per cubic meter, measured at 23° C. Within this range, the density can be 50 to 100 kilograms per cubic meter, specifically 60 to 90 kilograms per cubic meter, more specifically 65 to 85 kilograms per cubic meter.

Another embodiment is a method of making a foamed material, the method comprising melt blending in an extruder components comprising, based on the total weight of the foamed material, 45 to 82 weight percent of a poly(phenylene ether), a poly(phenylene ether)-polysiloxane block copolymer, or a combination thereof, 10 to 47 weight percent of a polystyrene, and 8 to 20 weight percent of an organophosphate ester to form a molten thermoplastic composition; adding a blowing agent to the extruder at a rate of 2 to 10 weight percent, specifically 3 to 8 weight percent, based on the weight of the molten thermoplastic composition to form a pre-foamed molten thermoplastic composition, wherein the blowing agent is selected from the group consisting of propane, 2-methylpropane, n-butane, 2-methylbutane, n-pentane, neopentane, and combinations thereof; and extruding the pre-foamed molten thermoplastic composition from the extruder to form the foamed material; wherein the foamed material has a density of 30 to 100 kilograms per cubic meter, measured at 23° C.; and wherein weight percent values are based on the total weight of the foamed material.

The step of melt blending is conducted in an extruder, which can be, for example, a single-screw extruder, or a twin-screw extruder. The extruder can comprise independently heated zones, each of which can be operated a temperature of 20 to 340° C. Detailed extrusion conditions are described in the working examples below.

All of the variations described above in the context of the foamed material apply as well to the method of making the foamed material.

In a very specific embodiment of the method, the poly(phenylene ether), the poly(phenylene ether)-polysiloxane block copolymer, or the combination thereof consists of the poly(phenylene ether); the polystyrene comprises an atactic homopolystyrene having a melt flow index of 1.5 to 15 grams per 10 minutes, measured at 200° C. and 5 kilogram load according to ASTM D1238-13; the organophosphate ester comprises resorcinol bis(diphenyl phosphate); the foamed material comprises less than or equal to 1,500 parts per million by weight total of chlorine, bromine, and iodine, based on the total weight of the foamed material; and the foamed material comprises, based on the total weight of the foamed material, 48 to 75 weight percent of the poly(phenylene ether), the poly(phenylene ether)-polysiloxane block copolymer, or the combination thereof, 10 to 35 weight percent of the polystyrene, and 15 to 20 weight percent of the organophosphate ester.

In another very specific embodiment of the method, the poly(phenylene ether), the poly(phenylene ether)-polysiloxane block copolymer, or the combination thereof consists of the combination of the poly(phenylene ether) and the poly(phenylene ether)-polysiloxane block copolymer; the polystyrene comprises an atactic homopolystyrene having a melt flow index of 1.5 to 15 grams per 10 minutes, measured at 200° C. and 5 kilogram load according to ASTM D1238-13; the organophosphate ester comprises resorcinol bis(diphenyl phosphate); the foamed material comprises less than or equal to 1,500 parts per million by weight total of chlorine, bromine, and iodine, based on the total weight of the foamed material; and the foamed material comprises, based on the total weight of the foamed material, 48 to 75 weight percent of the poly(phenylene ether), the poly(phenylene ether)-polysiloxane block copolymer, or the combination thereof, 10 to 35 weight percent of the polystyrene, and 15 to 20 weight percent of the organophosphate ester.

Another embodiment is an article comprising the foamed material in any of its above-described variations. Illustrative articles include wall insulation, ceiling insulation, insulation for attics and crawl spaces, backing for exterior siding, interior trim, interior signs, plenums, refrigerator insulation, and freezer insulation.

The invention includes at least the following embodiments.

Embodiment 1: A foamed material comprising, based on the total weight of the foamed material: 45 to 82 weight percent of a poly(phenylene ether), a poly(phenylene ether)-polysiloxane block copolymer, or a combination thereof; 10 to 47 weight percent of a polystyrene; and 8 to 20 weight percent of an organophosphate ester; wherein the foamed material has a density of 30 to 100 kilograms per cubic meter, measured at 23° C.; wherein the foamed material is the product of a process comprising melt blending in an extruder the poly(phenylene ether), the poly(phenylene ether)-polysiloxane block copolymer, or the combination thereof, the polystyrene, and the organophosphate ester to form a molten thermoplastic composition, adding a blowing agent to the extruder at a rate of 2 to 10 weight percent based on the weight of the molten thermoplastic composition to form a pre-foamed molten thermoplastic composition, wherein the blowing agent is selected from the group consisting of propane, 2-methylpropane, n-butane, 2-methylbutane, n-pentane, neopentane, and combinations thereof, and extruding the pre-foamed molten thermoplastic composition from the extruder to form the foamed material.

Embodiment 2: The foamed material of embodiment 1, wherein the poly(phenylene ether), the poly(phenylene ether)-polysiloxane block copolymer, or the combination thereof has an intrinsic viscosity of 0.29 to 0.45 deciliter per gram, measured at 25° C. in chloroform.

Embodiment 3: The foamed material of embodiment 1 or 2, wherein the poly(phenylene ether), the poly(phenylene ether)-polysiloxane block copolymer, or the combination thereof consists of the poly(phenylene ether).

Embodiment 4: The foamed material of embodiment 1 or 2, wherein the poly(phenylene ether), the poly(phenylene ether)-polysiloxane block copolymer, or the combination thereof consists of the combination of the poly(phenylene ether) and the poly(phenylene ether)-polysiloxane block copolymer.

Embodiment 5: The foamed material of any one of embodiments 1-4, wherein the polystyrene comprises an atactic homopolystyrene having a melt flow index of 1.5 to 15 grams per 10 minutes, measured at 200° C. and 5 kilogram load according to ASTM D1238-13.

Embodiment 6: The foamed material of any one of embodiments 1-5, wherein the organophosphate ester comprises resorcinol bis(diphenyl phosphate).

Embodiment 7: The foamed material of any one of embodiments 1-6, comprising less than or equal to 1,500 parts per million by weight total of chlorine, bromine, and iodine, based on the total weight of the foamed material.

Embodiment 8: The foamed material of embodiment 1, wherein the poly(phenylene ether), the poly(phenylene ether)-polysiloxane block copolymer, or the combination thereof consists of the poly(phenylene ether); wherein the polystyrene comprises an atactic homopolystyrene having a melt flow index of 1.5 to 15 grams per 10 minutes, measured at 200° C. and 5 kilogram load according to ASTM D1238-13; wherein the organophosphate ester comprises resorcinol bis(diphenyl phosphate); wherein the foamed material comprises less than or equal to 1,500 parts per million by weight total of chlorine, bromine, and iodine, based on the total weight of the foamed material; and wherein the foamed material comprises, based on the total weight of the foamed material, 48 to 75 weight percent of the poly(phenylene ether), the poly(phenylene ether)-polysiloxane block copolymer, or the combination thereof, 10 to 35 weight percent of the polystyrene, and 15 to 20 weight percent of the organophosphate ester.

Embodiment 9: The foamed material of embodiment 1, wherein the poly(phenylene ether), the poly(phenylene ether)-polysiloxane block copolymer, or the combination thereof consists of the combination of the poly(phenylene ether) and the poly(phenylene ether)-polysiloxane block copolymer; wherein the polystyrene comprises an atactic homopolystyrene having a melt flow index of 1.5 to 15 grams per 10 minutes, measured at 200° C. and 5 kilogram load according to ASTM D1238-13; wherein the organophosphate ester comprises resorcinol bis(diphenyl phosphate); wherein the foamed material comprises less than or equal to 1,500 parts per million by weight total of chlorine, bromine, and iodine, based on the total weight of the foamed material; and wherein the foamed material comprises, based on the total weight of the foamed material, 48 to 75 weight percent of the poly(phenylene ether), the poly(phenylene ether)-polysiloxane block copolymer, or the combination thereof, 10 to 35 weight percent of the polystyrene, and 15 to 20 weight percent of the organophosphate ester.

Embodiment 10: A method of making a foamed material, the method comprising melt blending in an extruder components comprising, based on the total weight of the foamed material, 45 to 82 weight percent of a poly(phenylene ether), a poly(phenylene ether)-polysiloxane block copolymer, or a combination thereof, 10 to 47 weight percent of a polystyrene, and 8 to 20 weight percent of an organophosphate ester to form a molten thermoplastic composition; adding a blowing agent to the extruder at a rate of 2 to 10 weight percent based on the weight of the molten thermoplastic composition to form a pre-foamed molten thermoplastic composition, wherein the blowing agent is selected from the group consisting of propane, 2-methylpropane, n-butane, 2-methylbutane, n-pentane, neopentane, and combinations thereof; and extruding the pre-foamed molten thermoplastic composition from the extruder to form the foamed material; wherein the foamed material has a density of 30 to 100 kilograms per cubic meter, measured at 23° C.; and wherein weight percent values are based on the total weight of the foamed material.

Embodiment 11: The method of embodiment 10, wherein the poly(phenylene ether), the poly(phenylene ether)-polysiloxane block copolymer, or the combination thereof has an intrinsic viscosity of 0.29 to 0.45 deciliter per gram, measured at 25° C. in chloroform.

Embodiment 12: The method of embodiment 10 or 11, wherein the poly(phenylene ether), the poly(phenylene ether)-polysiloxane block copolymer, or the combination thereof consists of the poly(phenylene ether).

Embodiment 13: The method of embodiment 10 or 11, wherein the poly(phenylene ether), the poly(phenylene ether)-polysiloxane block copolymer, or the combination thereof consists of the combination of the poly(phenylene ether) and the poly(phenylene ether)-polysiloxane block copolymer.

Embodiment 14: The method of any one of embodiments 10-13, wherein the polystyrene comprises an atactic homopolystyrene having a melt flow index of 1.5 to 15 grams per 10 minutes, measured at 200° C. and 5 kilogram load according to ASTM D1238-13.

Embodiment 15: The method of any one of embodiments 10-14, wherein the organophosphate ester comprises resorcinol bis(diphenyl phosphate).

Embodiment 16: The method of any one of embodiments 10-15, comprising less than or equal to 1,500 parts per million by weight total of chlorine, bromine, and iodine, based on the total weight of the foamed material.

Embodiment 17: The method of embodiment 10, wherein the poly(phenylene ether), the poly(phenylene ether)-polysiloxane block copolymer, or the combination thereof consists of the poly(phenylene ether); wherein the polystyrene comprises an atactic homopolystyrene having a melt flow index of 1.5 to 15 grams per 10 minutes, measured at 200° C. and 5 kilogram load according to ASTM D1238-13; wherein the organophosphate ester comprises resorcinol bis(diphenyl phosphate); wherein the foamed material comprises less than or equal to 1,500 parts per million by weight total of chlorine, bromine, and iodine, based on the total weight of the foamed material; and wherein the foamed material comprises, based on the total weight of the foamed material, 48 to 75 weight percent of the poly(phenylene ether), the poly(phenylene ether)-polysiloxane block copolymer, or the combination thereof, 10 to 35 weight percent of the polystyrene, and 15 to 20 weight percent of the organophosphate ester.

Embodiment 18: The method of embodiment 10, wherein the poly(phenylene ether), the poly(phenylene ether)-polysiloxane block copolymer, or the combination thereof consists of the combination of the poly(phenylene ether) and the poly(phenylene ether)-polysiloxane block copolymer; wherein the polystyrene comprises an atactic homopolystyrene having a melt flow index of 1.5 to 15 grams per 10 minutes, measured at 200° C. and 5 kilogram load according to ASTM D1238-13; wherein the organophosphate ester comprises resorcinol bis(diphenyl phosphate); wherein the foamed material comprises less than or equal to 1,500 parts per million by weight total of chlorine, bromine, and iodine, based on the total weight of the foamed material; and wherein the foamed material comprises, based on the total weight of the foamed material, 48 to 75 weight percent of the poly(phenylene ether), the poly(phenylene ether)-polysiloxane block copolymer, or the combination thereof, 10 to 35 weight percent of the polystyrene, and 15 to 20 weight percent of the organophosphate ester.

Embodiment 19: An article comprising the foamed material of any one of embodiments 1-9.

Embodiment 20: The article of embodiment 19, selected from the group consisting of wall insulation, ceiling insulation, insulation for attics and crawl spaces, backing for exterior siding, interior trim, interior signs, plenums, refrigerator insulation, and freezer insulation.

All ranges disclosed herein are inclusive of the endpoints, and the endpoints are independently combinable with each other. Each range disclosed herein constitutes a disclosure of any point or sub-range lying within the disclosed range.

The invention is further illustrated by the following non-limiting examples.

### Preparation of Unfoamed Materials

Components used to prepare unfoamed and foamed materials are summarized in Table 1.

TABLE 1

| Component | Description |
|---|---|
| PPE | Poly(2,6-dimethyl-1,4-phenylene ether), CAS Reg. No. 24938-67-8, |
| | having an intrinsic viscosity of about 0.30 deciliter per gram as |
| | measured in chloroform at 25° C.; obtained as PPO ™ 808 Resin from |
| | SABIC Innovative Plastics. |
| PPE-Si | A mixture of poly(2,6-dimethyl-1,4-phenylene ether) (CAS Reg. No. |
| | 24938-67-8) and poly(2,6-dimethyl-1,4-phenylene ether- |
| | polydimethylsiloxane block copolymer (CAS Reg. No. |
| | 1202019-56-4), the mixture having a polysiloxane content of about 5 |
| | weight percent and an intrinsic viscosity of about 0.40 deciliter per |
| | gram as measured in chloroform at 25° C.; prepared according to the |
| | procedure of U.S. Pat. No. 8,017,697 to Carrillo et al., Example 16. |
| PS | Atactic polystyrene, CAS Reg. No. 9003-53-6, having no mineral oil |
| | content and a melt flow index of about 7 grams per 10 minutes |
| | measured at 200° C. and 5 kilogram load; obtained as 153 F. from |
| | NOVA Chemicals. |
| RDP | Resorcinol bis(diphenyl phosphate), CAS Reg. No. 57583-54-7; |
| | obtained as CR-733S from Daihachi Chemical., as FYROLFLEX ™ |
| | RDP from ICL Industrial Products, as PHIREGUARD ™ RDP from |
| | Jiangsu Yoke Technology Co., Ltd, or as WSFR-RDP ™ from |
| | Zhejiang Wansheng Co., Ltd. |
| Talc MB | Masterbatch of 50 weight percent talc in polyethylene; obtained as |
| | Polybatch FPE 50 T NATURAL ASBAG 25 from A. Schulman. |
| Isobutane | Isobutane (2-methylpropane), CAS Reg. No. 75-28-5. |

Unfoamed thermoplastic compositions are summarized in Tables 2-4, where component amounts are expressed in weight percent based on the total weight of the composition. For each composition, glass transition temperature (T_{g}) values were determined according to ASTM D3418-03, Section 10.

TABLE 2

| | | | | |
|---|---|---|---|---|
| Sample 1 | Sample 2 | Sample 3 | Sample 4 | Sample 5 |

COMPOSITIONS

| | | | | | |
|---|---|---|---|---|---|
| PPE | 50 | 50 | 70 | 70 | 60 |
| PS | 40 | 32 | 20 | 12 | 26 |
| RDP | 10 | 18 | 10 | 18 | 14 |
| total | 100 | 100 | 100 | 100 | 100 |

PROPERTY

| | | | | | |
|---|---|---|---|---|---|
| T_{g} (° C.) | 122 | 103 | 139 | 121 | 118 |

TABLE 3

| | | | | |
|---|---|---|---|---|
| Sample 1 | Sample 2 | Sample 3 | Sample 4 | Sample 5 |

COMPOSITIONS

| | | | | | |
|---|---|---|---|---|---|
| PPE-Si | 50 | 50 | 70 | 70 | 60 |
| PS | 40 | 32 | 20 | 12 | 26 |
| RDP | 10 | 18 | 10 | 18 | 14 |
| total | 100 | 100 | 100 | 100 | 100 |

PROPERTY

| | | | | | |
|---|---|---|---|---|---|
| T_{g} (° C.) | 122 | 103 | 139 | 121 | 118 |

TABLE 4

| | Sample 6 | Sample 7 | Sample 8 | Sample 9 |
|---|---|---|---|---|
| PPE | 50 | 70 | 0 | 0 |
| PPE-Si | 0 | 0 | 50 | 70 |
| PS | 32 | 12 | 32 | 12 |
| RDP | 18 | 18 | 18 | 18 |
| total | 100 | 100 | 100 | 100 |

### EXAMPLES 1-9

These examples illustrate the preparation of foamed materials. In Tables 5 and 6, component amounts are expressed in units of parts by weight, except for isobutane, which is expressed in units of milliliters per minute. The foams were produced on a small single-screw extruder with foam-cooling sections. Extruder torque values are expressed in units of Newton-meters. Density values, expressed in units of kilograms per meter³, were determined at 23° C. by cutting a rectangular prism-shaped piece of foam from an extruded board, measuring the length, width, and thickness of the piece, and weighing the piece; density values were calculated by dividing the mass, in kilograms, by the volume, in meter³.

TABLE 5

| | | | | |
|---|---|---|---|---|
| Example 1 | Example 2 | Example 3 | Example 4 | Example 5 |

COMPOSITIONS

| | | | | | |
|---|---|---|---|---|---|
| PPE (pbw) | 50 | 50 | 70 | 70 | 60 |
| PS (pbw) | 40 | 32 | 20 | 12 | 26 |
| RDP (pbw) | 10 | 18 | 10 | 18 | 14 |
| Talc MB (pbw) | 2 | 2 | 2 | 2 | 2 |
| Isobutane (mL/min) | 6 | 5 | 6 | 6 | 6 |

EXTRUSION CONDITIONS

| | | | | | |
|---|---|---|---|---|---|
| Die dimensions (mm) | 25 × 0.75 | 25 × 0.75 | 25 × 0.75 | 25 × 0.75 | 25 × 0.75 |

Temperature Settings

| | | | | | |
|---|---|---|---|---|---|
| Zone 1 temp. (° C.) | 37 | 24 | 22 | 22 | 48 |
| Zone 2 temp. (° C.) | 241 | 239 | 275 | 274 | 240 |
| Zone 3 temp. (° C.) | 287 | 290 | 316 | 315 | 288 |
| Zone 4 temp. (° C.) | 291 | 288 | 323 | 322 | 298 |
| Zone 5 temp. (° C.) | 270 | 270 | 312 | 311 | 290 |
| Zone 6 temp. (° C.) | 260 | 260 | 300 | 301 | 280 |
| Static mixer 1 temp. (° C.) | 153 | 159 | 165 | 178 | 157 |
| Static mixer 2 temp. (° C.) | 153 | 159 | 165 | 177 | 157 |
| Static mixer 3 temp. (° C.) | 152 | 158 | 162 | 175 | 157 |
| Die temp. (° C.) | 157 | 157 | 178 | 178 | 160 |

Other Settings

| | | | | | |
|---|---|---|---|---|---|
| Screw rotation rate (rpm) | 75 | 75 | 75 | 55 | 75 |
| Throughput (g/hr) | 3000 | 3000 | 3000 | 3000 | 3000 |
| Extruder torque (N-m) | 235 | 167 | 177 | 167 | 167 |
| Extruder pressure (bar) | 230 | 60 | 75 | 54 | 63 |
| Die pressure (bar) | 48 | 25 | 34 | 30 | 34 |

Measured Values

| | | | | | |
|---|---|---|---|---|---|
| Melt temp. at die (° C.) | 161 | 164 | 185 | 185 | 170 |
| Isobutane injection rate | 5.92 | 5.13 | 5.95 | 6.00 | 5.92 |
| (mL/min) | | | | | |
| Foam density (kg/m³) | 60 | 60 | 61 | 96 | 67 |

TABLE 6

| | | | |
|---|---|---|---|
| Example 6 | Example 7 | Example 8 | Example 9 |

COMPOSITIONS

| | | | | |
|---|---|---|---|---|
| PPE-Si (pbw) | 50 | 50 | 70 | 60 |
| PS (pbw) | 40 | 32 | 20 | 26 |
| RDP (pbw) | 10 | 18 | 10 | 14 |
| Talc MB (pbw) | 2 | 2 | 2 | 2 |
| Isobutane (mL/min) | 4 | 4 | 4 | 6 |

EXTRUSION CONDITIONS

| | | | | |
|---|---|---|---|---|
| Die dimensions (mm) | 25 × 0.75 | 25 × 0.75 | 25 × 0.75 | 25 × 0.75 |

Temperature Settings

| | | | | |
|---|---|---|---|---|
| Zone 1 temp. (° C.) | 24 | 35 | 28 | 48 |
| Zone 2 temp. (° C.) | 239 | 240 | 275 | 239 |
| Zone 3 temp. (° C.) | 289 | 289 | 316 | 290 |
| Zone 4 temp. (° C.) | 298 | 301 | 319 | 298 |
| Zone 5 temp. (° C.) | 290 | 290 | 312 | 285 |
| Zone 6 temp. (° C.) | 280 | 281 | 301 | 281 |
| Static mixer 1 temp. | 160 | 157 | 155 | 151 |
| (° C.) | | | | |
| Static mixer 2 temp. | 161 | 157 | 155 | 152 |
| (° C.) | | | | |
| Static mixer 3 temp. | 160 | 157 | 158 | 152 |
| (° C.) | | | | |
| Die temp. (° C.) | 160 | 159 | 180 | 160 |

Other Settings

| | | | | |
|---|---|---|---|---|
| Screw rotation rate (rpm) | 75 | 75 | 75 | 82 |
| Throughput (g/hr) | 3000 | 3000 | 3000 | 3000 |
| Extruder torque (N-m) | 167 | 167 | 196 | 186 |
| Extruder pressure (bar) | 92 | 52 | 142 | 132 |
| Die pressure (bar) | 39 | 23 | 40 | 58 |

Measured Values

| | | | | |
|---|---|---|---|---|
| Melt temp. at die (° C.) | 168 | 166 | 182 | 173 |
| Isobutane injection rate | 4.01 | 5.26 | 4.10 | 5.99 |
| (mL/min) | | | | |
| Foam density (kg/m³) | 53 | 56 | 94 | 52 |

### COMPARATIVE EXAMPLES 1 AND 2, EXAMPLES 10-13

In these experiments, a single screw foam extruder was used to produce foamed planks for flame retardancy and mechanical property tests.

TABLE 7

| | C. Ex. 1 | C. Ex. 2 | Ex. 10 | Ex. 11 | Ex. 12 | Ex. 13 |
|---|---|---|---|---|---|---|
| PPE (pbw) | 0 | 50 | 50 | 70 | 0 | 0 |
| PPE-Si (pbw) | 0 | 0 | 0 | 0 | 50 | 70 |
| PS (pbw) | 100 | 50 | 32 | 12 | 32 | 12 |
| RDP (pbw) | 0 | 0 | 18 | 18 | 18 | 18 |
| Isobutane | 4.3 | 5.1 | 3.9 | 4.4 | 3.9 | 5.1 |
| (mL/min) | | | | | | |
| Melt temp. | 150 | 193 | 166 | 156 | 159 | 160 |
| (° C.) | | | | | | |
| Die pressure | 51 | 33 | 30 | 47 | 42 | 47 |
| (bar) | | | | | | |
| Foam density | 58.4 | 74.4 | 60.5 | 59.9 | 61.9 | 61.8 |
| (kg/m³) | | | | | | |

Flame retardancy testing was conducted according to EN ISO 11925-2:2010. EN ISO 11925-2:2010 is the principal flame standard in Europe to classify materials for building applications. It is the generally accepted flame standard for construction materials for walls and ceilings (but not floorings).

The dimensions of the test specimens were 250×90×20 millimeters. The test specimens were cut to size from larger boards. The surface of the foam plates were not ideally flat as there was no calibrator used during the foam extrusion. To account for variations in dimensions, six samples per foam material were used for each of the surface and edge flame applications.

To conduct each test, a foam specimen was clamped in vertical position and subjected to a small propane flame for 15 seconds. The flame was applied both on the surface of the foam plate (6 tests) and on the edge of the foam plate (6 tests). The sample was marked 150 millimeters above the point where the flame was applied. After the 15 seconds of flame application the burner was removed from the sample and the specimens are observed for flame spread and the formation of flaming drips that potentially are formed from the foam sample and might ignite the paper positioned below the sample.

The criteria for a Class E rating are that the flame should not pass the 150 millimeter mark line and the paper positioned below the foam sample should not ignite by drips falling from the foam sample. These pass criteria apply to each individual test, 6 for surface testing and 6 for edge testing. The reported maximum flame height (in millimeters) and after burning time (in seconds) are not part of the test criteria but give additional details on the flaming behavior of the samples.

The results, presented in Tables 8-15, show that the inventive foams of Examples 10-13 passed the EN ISO 11925-2:2010 test for a Class E rating under both surface and edge test conditions. In other words, none of the samples exhibited flame spread across the 150 millimeter mark and none of the samples exhibited ignition of the paper below the flame test set up.

TABLE 8
Surface flame retardancy of the Example 10 foam.

| | | | mark line 150 mm | | |
|---|---|---|---|---|---|
| | surface | max. flame | reached? | after burning | ignition of |
| Sample | ignition? Y/N | height (mm) | Y/N | time (sec) | paper? Y/N |
| 1 | Y | 110 | not reached | 0 | N |
| 2 | Y | 105 | not reached | >60 | N |
| 3 | Y | 102 | not reached | >60 | N |
| 4 | Y | 90 | not reached | 10 | N |
| 5 | Y | 80 | not reached | 0 | N |
| 6 | Y | 90 | not reached | >60 | N |
| avg. ± std. dev. | | 96 ± 11 | | 32 ± 31 | |

| | | |
|---|---|---|
| overall | 150 mm mark not reached within 20 sec | N |

TABLE 9
Edge flame retardancy of the Example 10 foam.

| | | | mark line 150 mm | | |
|---|---|---|---|---|---|
| | edge ignition? | max. flame | reached? | after burning | ignition of |
| Sample | Y/N | height (mm) | Y/N | time (sec) | paper? Y/N |
| 1 | Y | 30 | not reached | 0 | N |
| 2 | Y | 50 | not reached | 0 | N |
| 3 | Y | 45 | not reached | 0 | N |
| 4 | Y | 43 | not reached | 0 | N |
| 5 | Y | 30 | not reached | 0 | N |
| 6 | Y | 42 | not reached | 0 | N |
| avg. ± std. dev. | | 40 ± 8 | | 0 ± 0 | |

| | | |
|---|---|---|
| overall | 150 mm mark not reached within 20 sec | N |

TABLE 10
Surface flame retardancy of the Example 11 foam.

| | | | mark line 150 mm | | |
|---|---|---|---|---|---|
| | surface | max. flame | reached? | after burning | ignition of |
| Sample | ignition? Y/N | height (mm) | Y/N | time (sec) | paper? Y/N |
| 1 | Y | 58 | not reached | 0 | N |
| 2 | Y | 54 | not reached | 0 | N |
| 3 | Y | 52 | not reached | 0 | N |
| 4 | Y | 57 | not reached | 0 | N |
| 5 | Y | 57 | not reached | 0 | N |
| 6 | Y | 48 | not reached | 0 | N |
| avg. ± std. dev. | | 54 ± 4 | | 0 ± 0 | |

| | | |
|---|---|---|
| overall | 150 mm mark not reached within 20 sec | N |

TABLE 11
Edge flame retardancy of the Example 11 foam.

| | | | mark line 150 mm | | |
|---|---|---|---|---|---|
| | edge ignition? | max. flame | reached? | after burning | ignition of |
| Sample | Y/N | height (mm) | Y/N | time (sec) | paper? Y/N |
| 1 | Y | 30 | not reached | 0 | N |
| 2 | Y | 37 | not reached | 0 | N |
| 3 | Y | 26 | not reached | 0 | N |
| 4 | Y | 25 | not reached | 0 | N |
| 5 | Y | 25 | not reached | 0 | N |
| 6 | Y | 22 | not reached | 0 | N |
| avg. ± std. dev. | | 28 ± 5 | | 0 ± 0 | |

| | | |
|---|---|---|
| overall | 150 mm mark not reached within 20 sec | N |

TABLE 12
Surface flame retardancy of the Example 12 foam.

| | | | mark line 150 mm | | |
|---|---|---|---|---|---|
| | surface | max. flame | reached? | after burning | ignition of |
| Sample | ignition? Y/N | height (mm) | Y/N | time (sec) | paper? Y/N |
| 1 | Y | 64 | not reached | 2 | N |
| 2 | Y | 55 | not reached | 0 | N |
| 3 | Y | 65 | not reached | 25 | N |
| 4 | Y | 67 | not reached | 40 | N |
| 5 | Y | 57 | not reached | 0 | N |
| 6 | Y | 52 | not reached | 0 | N |
| avg. ± std. dev. | | 60 ± 6 | | 11 ± 17 | |

| | | |
|---|---|---|
| overall | 150 mm mark not reached within 20 sec | N |

TABLE 13
Edge flame retardancy of the Example 12 foam.

| | | | mark line 150 mm | | |
|---|---|---|---|---|---|
| | edge ignition? | max. flame | reached? | after burning | ignition of |
| Sample | Y/N | height (mm) | Y/N | time (sec) | paper? Y/N |
| 1 | Y | 30 | not reached | 0 | N |
| 2 | Y | 33 | not reached | 0 | N |
| 3 | Y | 33 | not reached | 0 | N |
| 4 | Y | 40 | not reached | 0 | N |
| 5 | Y | 33 | not reached | 0 | N |
| 6 | Y | 30 | not reached | 0 | N |
| avg. ± std. dev. | | 33 ± 4 | | 0 ± 0 | |

| | | |
|---|---|---|
| overall | 150 mm mark not reached within 20 sec | N |

TABLE 14
Surface flame retardancy of the Example 13 foam.

| | | | mark line 150 mm | | |
|---|---|---|---|---|---|
| | surface | max. flame | reached? | after burning | ignition of |
| Sample | ignition? Y/N | height (mm) | Y/N | time (sec) | paper? Y/N |
| 1 | Y | 60 | not reached | 0 | N |
| 2 | Y | 54 | not reached | 3 | N |
| 3 | Y | 45 | not reached | 0 | N |
| 4 | Y | 70 | not reached | 0 | N |
| 5 | Y | 56 | not reached | 6 | N |
| 6 | Y | 75 | not reached | 0 | N |
| avg. ± std. dev. | | 60 ± 11 | | 1.5 ± 2.3 | |

| | | |
|---|---|---|
| overall | 150 mm mark not reached within 20 sec | N |

TABLE 15
Edge flame retardancy of the Example 13 foam.

| | | | mark line 150 mm | | |
|---|---|---|---|---|---|
| | edge ignition? | max. flame | reached? | after burning | ignition of |
| Sample | Y/N | height (mm) | Y/N | time (sec) | paper? Y/N |
| 1 | Y | 47 | not reached | 0 | N |
| 2 | Y | 42 | not reached | 0 | N |
| 3 | Y | 45 | not reached | 0 | N |
| 4 | Y | 40 | not reached | 0 | N |
| 5 | Y | 50 | not reached | 0 | N |
| 6 | Y | 45 | not reached | 0 | N |
| avg. ± std. dev. | | 45 ± 4 | | 0 ± 0 | |

| | | |
|---|---|---|
| overall | 150 mm mark not reached within 20 sec | N |

1. A foamed material comprising, based on the total weight of the foamed material:
45 to 82 weight percent of a poly(phenylene ether), a poly(phenylene ether)-polysiloxane block copolymer, or a combination thereof;
10 to 47 weight percent of a polystyrene; and
8 to 20 weight percent of an organophosphate ester;
wherein the foamed material has a density of 30 to 100 kilograms per cubic meter, measured at 23° C.;
wherein the foamed material is the product of a process comprising
melt blending in an extruder
the poly(phenylene ether), the poly(phenylene ether)-polysiloxane block copolymer, or the combination thereof,
the polystyrene, and
the organophosphate ester
to form a molten thermoplastic composition,
adding a blowing agent to the extruder at a rate of 2 to 10 weight percent based on the weight of the molten thermoplastic composition to form a pre-foamed molten thermoplastic composition, wherein the blowing agent is selected from the group consisting of propane, 2-methylpropane, n-butane, 2-methylbutane, n-pentane, neopentane, and combinations thereof, and
extruding the pre-foamed molten thermoplastic composition from the extruder to form the foamed material.

2. The foamed material of claim 1, wherein the poly(phenylene ether), the poly(phenylene ether)-polysiloxane block copolymer, or the combination thereof has an intrinsic viscosity of 0.29 to 0.45 deciliter per gram, measured at 25° C. in chloroform.

3. The foamed material of claim 1, wherein the poly(phenylene ether), the poly(phenylene ether)-polysiloxane block copolymer, or the combination thereof consists of the poly(phenylene ether).

4. The foamed material of claim 1, wherein the poly(phenylene ether), the poly(phenylene ether)-polysiloxane block copolymer, or the combination thereof consists of the combination of the poly(phenylene ether) and the poly(phenylene ether)-polysiloxane block copolymer.

5. The foamed material of claim 1, wherein the polystyrene comprises an atactic homopolystyrene having a melt flow index of 1.5 to 15 grams per 10 minutes, measured at 200° C. and 5 kilogram load according to ASTM D1238-13.

6. The foamed material of claim 1, wherein the organophosphate ester comprises resorcinol bis(diphenyl phosphate).

7. The foamed material claim 1, comprising less than or equal to 1,500 parts per million by weight total of chlorine, bromine, and iodine, based on the total weight of the foamed material.

8. The foamed material of claim 1,
wherein the poly(phenylene ether), the poly(phenylene ether)-polysiloxane block copolymer, or the combination thereof consists of the poly(phenylene ether);
wherein the polystyrene comprises an atactic homopolystyrene having a melt flow index of 1.5 to 15 grams per 10 minutes, measured at 200° C. and 5 kilogram load according to ASTM D1238-13;
wherein the organophosphate ester comprises resorcinol bis(diphenyl phosphate);
wherein the foamed material comprises less than or equal to 1,500 parts per million by weight total of chlorine, bromine, and iodine, based on the total weight of the foamed material; and
wherein the foamed material comprises, based on the total weight of the foamed material,
48 to 75 weight percent of the poly(phenylene ether), the poly(phenylene ether)-polysiloxane block copolymer, or the combination thereof,
10 to 35 weight percent of the polystyrene, and
15 to 20 weight percent of the organophosphate ester.

9. The foamed material of claim 1,
wherein the poly(phenylene ether), the poly(phenylene ether)-polysiloxane block copolymer, or the combination thereof consists of the combination of the poly(phenylene ether) and the poly(phenylene ether)-polysiloxane block copolymer;
wherein the polystyrene comprises an atactic homopolystyrene having a melt flow index of 1.5 to 15 grams per 10 minutes, measured at 200° C. and 5 kilogram load according to ASTM D1238-13;
wherein the organophosphate ester comprises resorcinol bis(diphenyl phosphate);
wherein the foamed material comprises less than or equal to 1,500 parts per million by weight total of chlorine, bromine, and iodine, based on the total weight of the foamed material; and
wherein the foamed material comprises, based on the total weight of the foamed material,
48 to 75 weight percent of the poly(phenylene ether), the poly(phenylene ether)-polysiloxane block copolymer, or the combination thereof,
10 to 35 weight percent of the polystyrene, and
15 to 20 weight percent of the organophosphate ester.

10. A method of making a foamed material, the method comprising
melt blending in an extruder components comprising, based on the total weight of the foamed material,
45 to 82 weight percent of a poly(phenylene ether), a poly(phenylene ether)-polysiloxane block copolymer, or a combination thereof,
10 to 47 weight percent of a polystyrene, and
8 to 20 weight percent of an organophosphate ester to form a molten thermoplastic composition;
adding a blowing agent to the extruder at a rate of 2 to 10 weight percent based on the weight of the molten thermoplastic composition to form a pre-foamed molten thermoplastic composition; wherein the blowing agent is selected from the group consisting of propane, 2-methylpropane, n-butane, 2-methylbutane, n-pentane, neopentane, and combinations thereof; and
extruding the pre-foamed molten thermoplastic composition from the extruder to form the foamed material;
wherein the foamed material has a density of 30 to 100 kilograms per cubic meter, measured at 23° C.; and
wherein weight percent values are based on the total weight of the foamed material.

11. The method of claim 10, wherein the poly(phenylene ether), the poly(phenylene ether)-polysiloxane block copolymer, or the combination thereof has an intrinsic viscosity of 0.29 to 0.45 deciliter per gram, measured at 25° C. in chloroform.

12. The method of claim 10, wherein the poly(phenylene ether), the poly(phenylene ether)-polysiloxane block copolymer, or the combination thereof consists of the poly(phenylene ether).

13. The method of claim 10, wherein the poly(phenylene ether), the poly(phenylene ether)-polysiloxane block copolymer, or the combination thereof consists of the combination of the poly(phenylene ether) and the poly(phenylene ether)-polysiloxane block copolymer.

14. The method of claim 10, wherein the polystyrene comprises an atactic homopolystyrene having a melt flow index of 1.5 to 15 grams per 10 minutes, measured at 200° C. and 5 kilogram load according to ASTM D1238-13.

15. The method of claim 10, wherein the organophosphate ester comprises resorcinol bis(diphenyl phosphate).

16. The method of claim 10, comprising less than or equal to 1,500 parts per million by weight total of chlorine, bromine, and iodine, based on the total weight of the foamed material.

17. The method of claim 10,
wherein the poly(phenylene ether), the poly(phenylene ether)-polysiloxane block copolymer, or the combination thereof consists of the poly(phenylene ether);
wherein the polystyrene comprises an atactic homopolystyrene having a melt flow index of 1.5 to 15 grams per 10 minutes, measured at 200° C. and 5 kilogram load according to ASTM D1238-13;
wherein the organophosphate ester comprises resorcinol bis(diphenyl phosphate);
wherein the foamed material comprises less than or equal to 1,500 parts per million by weight total of chlorine, bromine, and iodine, based on the total weight of the foamed material; and
wherein the foamed material comprises, based on the total weight of the foamed material,
48 to 75 weight percent of the poly(phenylene ether), the poly(phenylene ether)-polysiloxane block copolymer, or the combination thereof,
10 to 35 weight percent of the polystyrene, and
15 to 20 weight percent of the organophosphate ester.

18. The method of claim 10,
wherein the poly(phenylene ether), the poly(phenylene ether)-polysiloxane block copolymer, or the combination thereof consists of the combination of the poly(phenylene ether) and the poly(phenylene ether)-polysiloxane block copolymer;
wherein the polystyrene comprises an atactic homopolystyrene having a melt flow index of 1.5 to 15 grams per 10 minutes, measured at 200° C. and 5 kilogram load according to ASTM D1238-13;
wherein the organophosphate ester comprises resorcinol bis(diphenyl phosphate);
wherein the foamed material comprises less than or equal to 1,500 parts per million by weight total of chlorine, bromine, and iodine, based on the total weight of the foamed material; and
wherein the foamed material comprises, based on the total weight of the foamed material,
48 to 75 weight percent of the poly(phenylene ether), the poly(phenylene ether)-polysiloxane block copolymer, or the combination thereof,
10 to 35 weight percent of the polystyrene, and
15 to 20 weight percent of the organophosphate ester.

19. An article comprising the foamed material of claim 1.

20. The article of claim 19, selected from the group consisting of wall insulation, ceiling insulation, insulation for attics and crawl spaces, backing for exterior siding, interior trim, interior signs, plenums, refrigerator insulation, and freezer insulation.
